(19) United States
(12) Patent Application Publication
(10) Pub. No.: US 2005/0275899 A1
(43) Pub. Date: Dec. 15, 2005

(54) Dithering method and related apparatus using aperiodic tiling rule

(76) Inventor: Ding-Yun Chen, HsinChu (TW)

Correspondence Address: NORTH AMERICA INTELLECTUAL PROPERTY CORPORATION, P.O. BOX 506, MERRIFIELD, VA, 22116, US

(21) Appl. No.: 10/908,233

(22) Filed: May 3, 2005

Related U.S. Application Data
(60) Provisional application No. 60/521,586, filed on May 28, 2004.

(51) Int. Cl. H04N 1/405; H04N 1/52

(52) U.S. Cl. 358/3.13; 358/535; 358/3.23

(57) ABSTRACT

The present invention discloses a dithering method and related apparatus that uses the tiling rule of Wang Tiles. The disclosed method includes the following steps: providing a plurality of dithering tiles, wherein each of the plurality of dithering tiles corresponds to a threshold array; generating at least one dithering mask with the plurality of dithering tiles according to the tiling rule of Wang Tiles; and comparing the pixel values of the image with corresponding threshold values of the dithering mask on a pixel-by-pixel basis to generate a halftone image of the image.

### CROSS REFERENCE TO RELATED APPLICATIONS

This application claims the benefit of U.S. Provisional Application No. 60/521,586, which was filed on May 28, 2004 and entitled “Aperiodic Wang-Tiling Mask for Halftoning”.

### BACKGROUND OF INVENTION

1. Field of the Invention

The present invention relates to a dithering method and a dithering apparatus, and more particularly, to a dithering method and a dithering apparatus for generating a dithering mask according to an aperiodic tiling rule.

2. Description of the Prior Art

In general, when processing or displaying a high quality image, a plurality of tones would be used for presenting the pixels of the high quality image. For instance, in a gray scale image with 256 different tones, any pixel of the image can be white (with pixel value 0), black (with pixel value 255), or gray (with pixel value between 1 and 254). The larger the pixel value, the darker the pixel is; and the smaller the pixel value, the whiter the pixel is. The quality of the image observed by human eyes improves as more tones are used for displaying the image.

However, some apparatuses such as a monochromatic printer and a low-level Display are only able to process a few number of tones. When such apparatuses process an image with plenty of tones, a halftone technique has to be used for transferring the image into an image with fewer tones.

Halftone algorithms can be briefly classified into three main categories: iteration algorithms, neighborhood algorithms, and point algorithms.

The iteration algorithm reduces the discrepancies between the halftone image and the original image by iterative operation. Although this algorithm provides better quality, it not only consumes a lot of time but also requires great memory space for storing the entire original image and the entire halftone image during the halftone process.

The neighborhood algorithm compares the pixel value of each pixel in the original image with a particular threshold value, and then diffuses the quantization error to the neighboring and un-processed pixels. Thus, the neighborhood algorithm is also called “error diffusion”. This method is faster and simpler than the iteration algorithm, but some unnatural visual artifacts might be left in the obtained halftone image. In addition, a convolution operation is required during the halftone process. Therefore, this algorithm still requires a great amount of computation and memory space for storing the error value during the halftone process.

The point algorithm designs a bigger dithering mask for dithering the entire image repeatedly. This method often results in unnatural periodic artifacts left in the obtained halftone image. In addition, this method needs a great amount of memory space to store the dithering mask.

There's another algorithm which designs several small dithering masks and uses these dithering masks randomly to dither the entire image. There are no particular rules for choosing the dithering masks such that this method often results in boundary artifacts in the halftone image. Additionally, the sizes of the small dithering masks should be large enough for increasing discrepancy between each of the dithering masks, so as to decrease the periodic artifacts left in the resulting halftone image.

### SUMMARY OF INVENTION

It is therefore an object of the present invention to provide a halftone method and related apparatus for solving the above-mentioned problems.

The embodiment of the present invention discloses a method for dithering an image. The method includes: providing a plurality of dithering tiles; generating at least one dithering mask with the dithering tiles according to an aperiodic rule, the tiling rule of Wang Tiles for example; and using the dithering mask for dithering the image, so as to obtain a halftone image.

The embodiment of the present invention also provides an apparatus for dithering an image, so as to obtain a halftone image. The apparatus includes: a first memory for storing a plurality of dithering tiles; a processing unit coupled to the first memory for generating at least one dithering mask with the dithering tiles according to an aperiodic rule, the tiling rule of Wang Tiles for example, and dithering the image with the dithering mask; and a second memory coupled to the processing unit for recording a usage history of the dithering tiles used by the processing unit while generating the dithering mask.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram illustrating an apparatus for dithering an image according to an embodiment of the present invention.

FIG. 2 is a flow chart illustrating how the apparatus shown in FIG. 1 halftones an image.

### DETAILED DESCRIPTION

The Wang Tiles is a concept proposed by Hao Wang in 1861. Each set of Wang Tiles is composed of a plurality of tiles of equal size. Each edge of every tile has a particular color. During the tiling process, the Wang Tiles requires that “adjacent edges of adjacent tiles must have the same color”.

A large irregular image is generated with few tiles according to the Wang Tiles. Therefore, the problem of a large irregular image occupying great memory space is overcome.

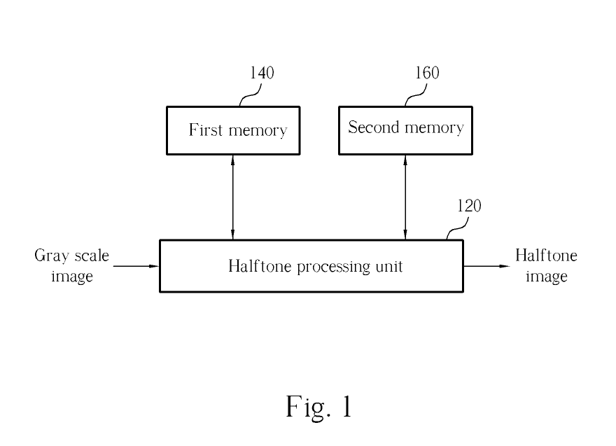

The present invention uses the aperiodic tiling rule, Wang Tiles for example, for dithering an image. FIG. 1 is a schematic diagram illustrating an embodiment of the present invention, in which a gray scale image is going to be dithered to generate a halftone image. Please note that the gray scale image serves only as an example. In practice the present invention can be used for dithering other kinds of images such as color images.

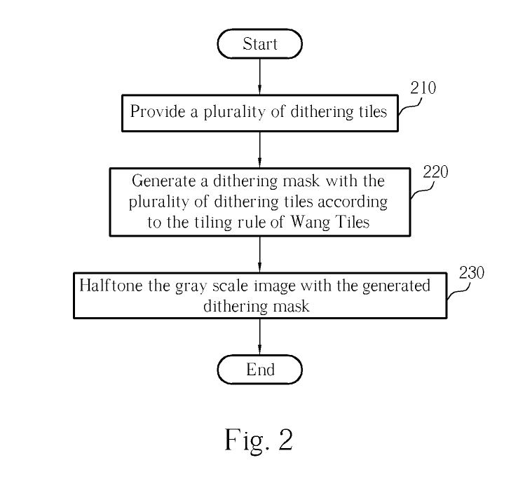

The apparatus shown in FIG. 1 includes a halftone processing unit 120, a first memory 140, and a second memory 160. FIG. 2 is a flow chart illustrating how the apparatus shown in FIG. 1 dithers an image. The steps are stated as follows.

Step 210: Provide a plurality of dithering tiles. Each edge of each dithering tile corresponds to a particular color, and each dithering tile corresponds to a threshold array. The values of the threshold arrays are adjustable. For instance, the values of the threshold arrays may change according to different applications, different printers or displays for example. Preferably, the values of the threshold array correspond to the colors of the edges of a dithering tile. However, this is not a limitation of the present invention. The values of a threshold array can be independent of the colors of the edges of a corresponding dithering tile. In this embodiment, the plurality of dithering tiles is stored in the first memory 140.

Step 220: Generate a dithering mask with the plurality of dithering tiles stored in the first memory 140 according to the tiling rule of Wang Tiles. In this embodiment, the size of the dithering mask is equal to or bigger than the size of the gray scale image that is going to be dithered. For instance, if the size of the gray scale image is 1600 pixels by 1200 pixels and the size of each dithering tile is 16 pixels by 16 pixels, each row of the dithering mask includes at least 100 dithering tiles and each column of the dithering mask includes at least 75 dithering tiles. During the tiling process, a usage history of those dithering tiles is recorded in the second memory 160.

In the concept of Wang Tiles, each edge of each dithering tile has a particular color. During the tiling process, the adjacent edges of adjacent tiles must have the same color. The present embodiment uses this concept of Wang Tiles for generating the dithering mask. The tiling rule is described as follows:
(a) Choose a first dithering tile randomly; and
(b) Choose another dithering tile that is going to be tiled next to the first dithering tile according to the color of the first dithering tile's edge. For instance, when choosing a second dithering tile that is going to be tiled to the right side of the first dithering tile, the color of the left edge of the second dithering tile must match the color of the right edge of the first dithering tile. If there is a plurality of dithering tiles that can be chosen as the second dithering tile, it will be chosen randomly among these tiles. Similarly, when choosing a third dithering tile that is going to be tiled under the second dithering tile, the color of the upper edge of the third dithering tile must match the color of the lower edge of the second dithering tile.

Step 230: Use the halftone processing unit 120 to dither the gray scale image with the generated dithering mask. One way for accomplishing this step is to compare the pixel value of each pixel in the gray scale image with the threshold value of the corresponding position in the dithering mask, thereby obtaining a resulting value. Finally, the array comprising all resulting values corresponds to the halftone image of the gray scale image. Please note that the mentioned method is referred to the point algorithm, however, this step can also be implemented with other algorithms such as the error diffusion algorithm, meaning that the quantization error of each pixel is diffused to the neighboring and unprocessed pixels during the halftone process.

Although this embodiment takes the gray scale image as an example, the present invention can be used for dithering other images with plenty of tones, such as color images. To dither a color image according to the present invention, one or more dithering masks can be used for respectively dithering the three primary colors, R (red), G (green), and B (blue) of the color image, that is to say the pixel values respectively corresponding to the three primary colors of the color image separately dithered, so as to dither the entire color image.

In addition, during the process of generating the dithering mask, dithering tiles previously used must be recorded to ensure that the mentioned tiling rule is maintained when choosing the next dithering tile. However, there are not many dithering tiles that can be chosen when selecting a new dithering tile because of the tiling rule. Therefore, not too much memory space is required to store the usage history. The second memory used to store the usage history of the dithering tiles of the mentioned embodiment can be integrated with the first memory as a single memory.

Besides, in order to design a set of dithering tiles, a genetic algorithm can be used to optimize the set. Accordingly, the designer can define a desired cost function, and redundant descriptions will be omitted here.

The size and the number of the dithering tiles used in the present invention has no particular limitations. Using bigger dithering tiles and more dithering tiles generates better quality in the halftone image but requires more memory space. It is simply a design choice.

Those skilled in the art will readily observe that numerous modifications and alterations of the device and method may be made while retaining the teachings of the invention. Accordingly, the above disclosure should be construed as limited only by the metes and bounds of the appended claims.

1. A method for dithering an image, comprising:
providing a plurality of dithering tiles;
generating at least one dithering mask with the plurality of dithering tiles according to an aperiodic tiling rule; and
dithering the image with the dithering mask, so as to obtain a halftone image.

2. The method of claim 1, wherein the aperiodic tiling rule is the tiling rule of Wang Tiles.

3. The method of claim 1, wherein the image is a gray scale image or a color image.

4. The method of claim 1, wherein the dithering tiles are generated according to a generic algorithm.

5. The method of claim 4, wherein the method utilizes at least one of the dithering masks to dither the three primary colors R, G, and B of the color image respectively.

6. The method of claim 1, wherein each of the dithering tiles corresponds to a threshold array.

7. The method of claim 6, wherein values of the threshold array are compared with the pixel values to halftone the image.

8. An apparatus for dithering an image, comprising:
a first memory for storing a plurality of dithering tiles; and
a processing unit coupled to the first memory for generating at least one dithering mask with the plurality of dithering tiles according to an aperiodic tiling rule, and for dithering the image with the dithering mask, so as to obtain a halftone image.

9. The apparatus of claim 8, further comprising:
a second memory, coupled to the processing unit, for recording a usage history of the plurality of dithering tiles.

10. The apparatus of claim 8, wherein the first memory further records a usage history of the plurality of dithering tiles.

11. The apparatus of claim 8, wherein the aperiodic tiling rule is the tiling rule of Wang Tiles.

12. The apparatus of claim 8, wherein each of the dithering tiles corresponds to a threshold array, and values of the threshold array are compared with pixel values of the image.

13. A method for generating a dithering mask, comprising:
providing a plurality of dithering tiles; and
generating at least one dithering mask with the plurality of dithering tiles according to an aperiodic tiling rule.

14. The method of claim 13, wherein the aperiodic tiling rule is the tiling rule of Wang Tiles.

15. The method of claim 13, wherein the dithering mask is for dithering an image, so as to obtain a halftone image.

16. The method of claim 15, wherein the image is a gray scale image or a color image.

17. The method of claim 15, wherein the dithering tiles are generated according to a generic algorithm.

18. The method of claim 17, wherein the method utilizes at least one of the dithering masks to dither three primary colors R, G, and B of the color image respectively.

19. The method of claim 15, wherein each of the dithering tiles corresponds to a threshold array, and the method compares values of the threshold arrays with pixel values of the image.
